(19) United States
(12) Patent Application Publication
(10) Pub. No.: US 2004/0254990 A1
(43) Pub. Date: Dec. 16, 2004

(54) System and method for knock notification to an unsolicited message

(75) Inventor: Ajay Mittal, Foster City, CA (US)

Correspondence Address: DARBY & DARBY P.C., P.O. BOX 5257, NEW YORK, NY, 10150-6257, US

(73) Assignee: Nokia, Inc., Irving, TX

(21) Appl. No.: 10/461,566

(22) Filed: Jun. 13, 2003

(51) Int. Cl. G06F 15/16

(52) U.S. Cl. 709/206; 709/203

(57) ABSTRACT

A system and method is directed to providing a knock notification in response to a message from an unknown sender. The method includes maintaining a data store of message senders that an end-user has identified as an allowed sender. A received message is evaluated to determine whether its sender is an allowed sender. If the sender is an allowed sender, the received message is forwarded to the end-user. If it is determined that the sender is an unknown sender, a knock notification message is generated. In one embodiment, the knock notification message includes the information about the sender and a mechanism to enable the end-user to allow/disallow the sender. If the end-user disallows the sender, the received message is discarded. Information associated with the disallowed sender is included in a data store for disallowed senders. The end-user may review and revise the data stores of allowed and disallowed senders.

### FIELD OF THE INVENTION

The present invention relates to network messages, and in particular to a system and method for generating and responding to a knock notification to an end-user for email from an unknown sender.

### BACKGROUND OF THE INVENTION

Today, millions of people worldwide use an Internet based email system to communicate. Such an email system may enable one to send hundreds of messages without incurring significant incremental costs over sending a single message. Some cyber-marketing companies use this feature to send messages to thousands, even millions, of people with virtually a click of a button. These messages may be advertisements, newsletters, educational materials, sermons on the sender's favorite topic, pleas for financial assistance, or scams intended to defraud the unwitting. Many of these messages may be messages that are unsolicited by the recipient. Since many of these unsolicited messages may be sent by automated applications, the message recipient may not be the right target audience.

Many businesses and individuals find unsolicited email, also known as “spam,” annoying and time consuming. Moreover, spam messages consume computing resources, email administrator and helpdesk personnel time, and reduce workers' and personal productivity. In a report by the European Commission, spam may cost businesses about ten billion dollars a year. Despite the increasing deployment of anti-spam services and technologies, the number of spam messages, and their size, is continuing to increase rapidly.

Recently, there have been numerous improvements in spam filtering technologies. However, current spam filtering technologies continue to suffer from several drawbacks. For example, many spam filters employ growing lists of different patterns for recognizing and removing spam emails. Maintaining these lists may become an unacceptably expensive solution for many individuals and businesses. Additionally, many spam filters are configured with minimum end-user input. This may result in filtering out of messages that the end-user may actually desire to receive. Therefore, it is with respect to these considerations, and others, that the present invention has been made.

### SUMMARY OF THE INVENTION

The present invention is directed to addressing the above-mentioned shortcomings, disadvantages and problems, and will be understood by reading and studying the following specification.

The present invention provides a system and method directed to generating and responding to a knock notification message to an end-user for a message from an unknown sender.

In one aspect of the present invention, a method is directed to managing a delivery of a message. The message is received from a sender. If the sender of the received message is an allowed sender, the received message is forwarded to a destination. If the sender is a disallowed sender, the received message is discarded. If the sender is an unknown sender, a knock notification message is forwarded to another destination.

In another aspect of the invention, a computer-readable medium having computer-executable components is directed to managing a delivery of a message. The computer-executable components include a mail delivery component and a knock manager component. The mail delivery component is configured to receive the message from a sender and to send the message to an end-user. The knock manager component receives the message, and if the sender of the message is an allowed sender, forwards the received message to an end-user. If the sender is a disallowed sender, the knock manager component discards the received message. If the sender is an unknown sender, the knock manager component forwards a knock notification message to the end-user. Moreover, in one aspect of the computer-readable medium, a response to the knock notification message is received from the end-user. When it is determined that the response indicates the unknown sender is allowed, the received message is forwarded to the end-user. When it is determined that the response indicates the unknown sender is disallowed, the received message is discarded.

In still another aspect of the invention, an apparatus is directed to managing a delivery of a message. The apparatus includes an input mechanism for receiving the message, and an output mechanism for transmitting the message to a destination. The apparatus further includes a means for forwarding the message to the destination based in part on whether the sender of the message is an allowed sender, and a means for discarding the message based in part on whether the sender of the message is a disallowed sender. The apparatus includes a means for generating a knock notification message based in part on whether the sender of the message is an unknown sender, and a means for receiving a response to the knock notification message. The apparatus includes a means for forwarding the received message, when the response indicates the unknown sender is allowed, and a means for discarding the received message when the response indicates the unknown sender is disallowed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates an exemplary environment in which a knock notifier may operate;

FIG. 2 illustrates components of an exemplary server environment in which the invention may be practiced;

FIG. 3 illustrates components of one embodiment of a knock notifier as shown in FIG. 1;

FIG. 4 illustrates a flow chart for one embodiment of an overview process for generating a knock notification message; and

FIG. 5 illustrates a flow chart for one embodiment of a process for managing a message from an unknown sender based in part on a response to a knock notification message, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The term “coupled,” and “connected,” include a direct connection between the things that are connected, or an indirect connection through one or more either passive or active intermediary devices or components.

The terms “comprising,” “including,” “containing,” “having,” and “characterized by,” include an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

Briefly stated, the present invention is directed towards a system and method for generating a knock notification message to an end-user for a message received from an unknown sender. The invention further manages the message based in part on a response from the end-user to the knock notification message. The invention includes maintaining a data store of a message sender that an end-user has identified as an allowed sender. A received message is evaluated to determine whether its identified sender is an allowed sender, as indicated in part by the allowed sender store. If the sender is an allowed sender, the received message is forwarded to the end-user. In one embodiment, the received message is forwarded to an email inbox associated with the end-user. If it is determined that the sender is an unknown sender, a knock notification message is generated. In one embodiment, the knock notification message includes information associated with the sender of the received message, and a mechanism to enable the end-user to allow/disallow the sender. The knock notification message may be forwarded to a knock message folder associated with the end-user. If the end-user disallows the sender, the received message is discarded. Information associated with the disallowed sender is entered into a disallowed senders' data store. The end-user may review and revise the contents of the allowed and disallowed senders' data stores.

Illustrative Operating Environment

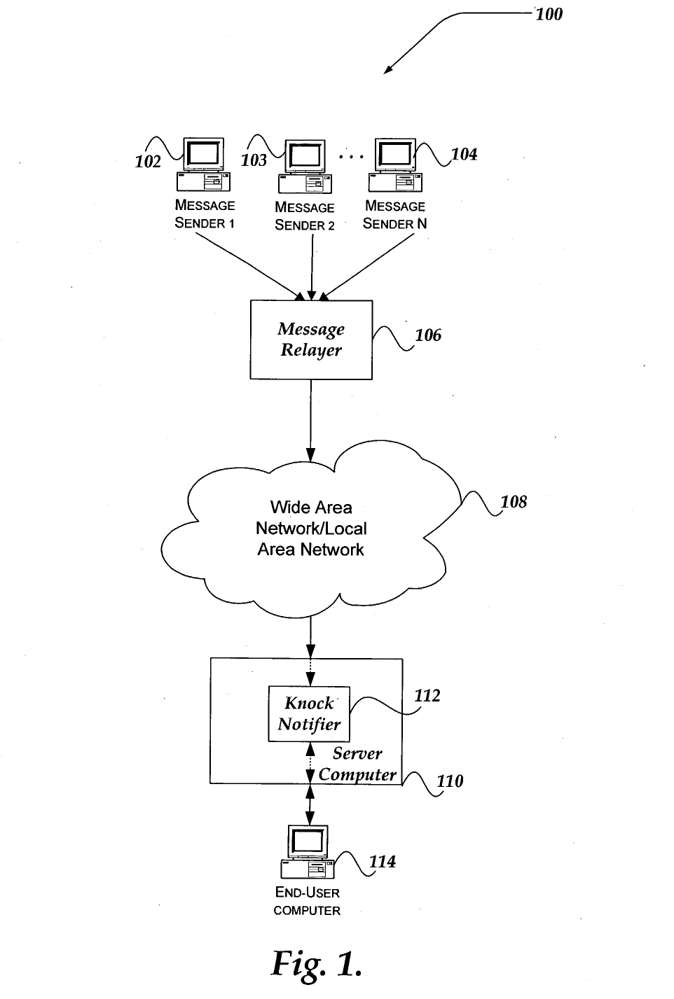

FIG. 1 illustrates an exemplary environment in which a knock notifier may operate. Not all of the components may be required to practice the invention, and variations in the arrangement and type of the components may be made without departing from the spirit or scope of the invention.

As shown in the figure, knock notification system 100 includes message senders 102-104, message relayer 106, Wide Area Network (WAN)/Local Area Network (LAN) 108, server computer 110, and end-user computer 114. Server computer 110 includes knock notifier 112.

Message relayer 106 is in communication with message senders 102-104, and WAN/LAN 108. WAN/LAN 108 is in communication with server computer 110 and knock notifier 112. Server computer 110 is also in communication with end-user computer 114.

Message senders 102-104 may include any device capable of sending a message over a network, such as WAN/LAN 108, towards end-user computer 114. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, message senders 102-104 may be any device that is capable of connecting using a wired or wireless communication medium such as a Personal Digital Assistant (PDA), POCKET PC, wearable computer, or other device mentioned above that is equipped to use a wired and/or wireless communication medium.

Message relayer 106 represents virtually any network device that receives and forwards a message towards a destination. Message relayer 106 may include a server computer, personal computer, multiprocessor system, microprocessor-based or programmable consumer electronics, network PC, router, gateway, and the like. Message relayer 106 may also be configured to operate as a mail server, website, and the like.

Message relayer 106 may receive the message from message senders 102-104, and forward it towards server computer 110 through WAN/LAN 108. Similarly, although not shown, message relayer 106 may receive another message from end-user 114, through server computer 110, and forward it towards at least one message sender 102-104.

WAN/LAN 108 represents a network infrastructure that couples message relayer 106 with server computer 110. WAN/LAN 108 is enabled to employ any form of computer readable media for communicating information from one electronic device to another. In addition, WAN/LAN 108 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, WAN/LAN 108 includes any communication method by which information may travel between message senders 102-104 and end-user computer 114.

Server computer 110 may include any computing device capable of connecting to end-user 112, to communicate information in the form of packets. Each packet may convey a piece of information. A packet may be sent for handshaking, i.e., to establish a connection or to acknowledge receipt of data. The packet may include information such as a request, response, an email message, and the like. Generally, packets received by server computer 110 will be formatted according to TCP/IP, but they could also be formatted using another transport protocol, such as User Datagram Protocol (UDP), Internet Control Message Protocol (ICMP), NETbeui, IPX/SPX, token ring, and the like.

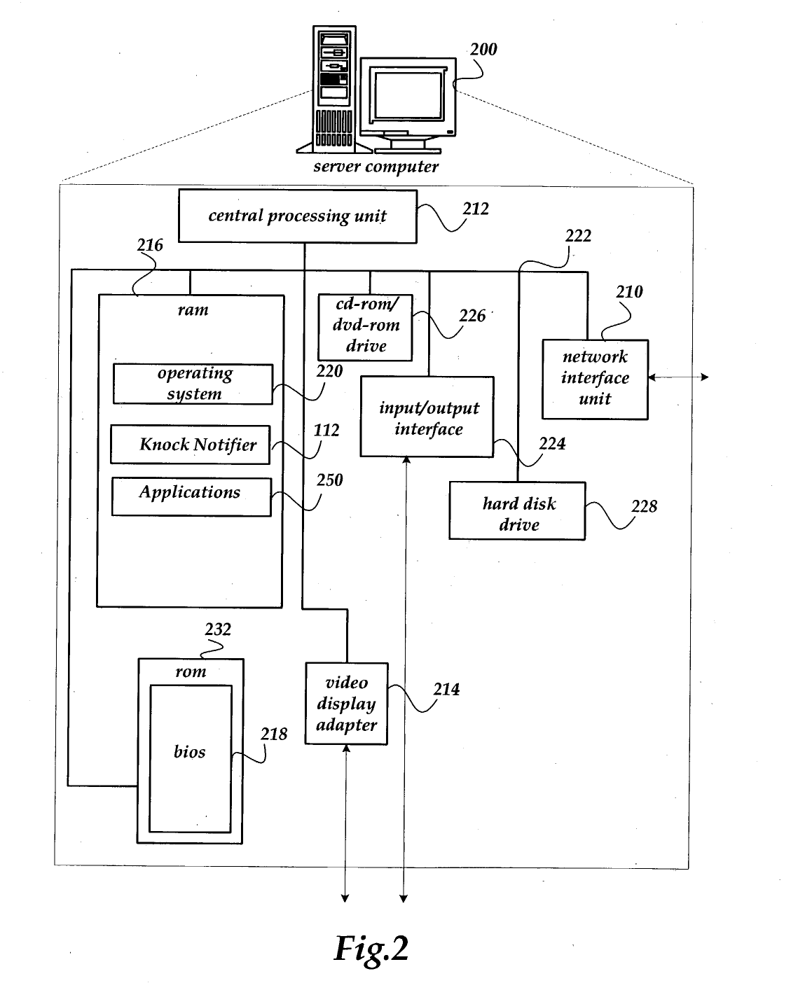

Devices that may operate as server computer 110 include, but are not limited to, personal computers desktop computers, multiprocessor systems, microprocessor-based or programmable consumer electronics, network PCs, servers, and the like. Server computer 110 may also be configured to operate as a mail server, website, and the like. FIG. 2 illustrates one embodiment of server computer 110.

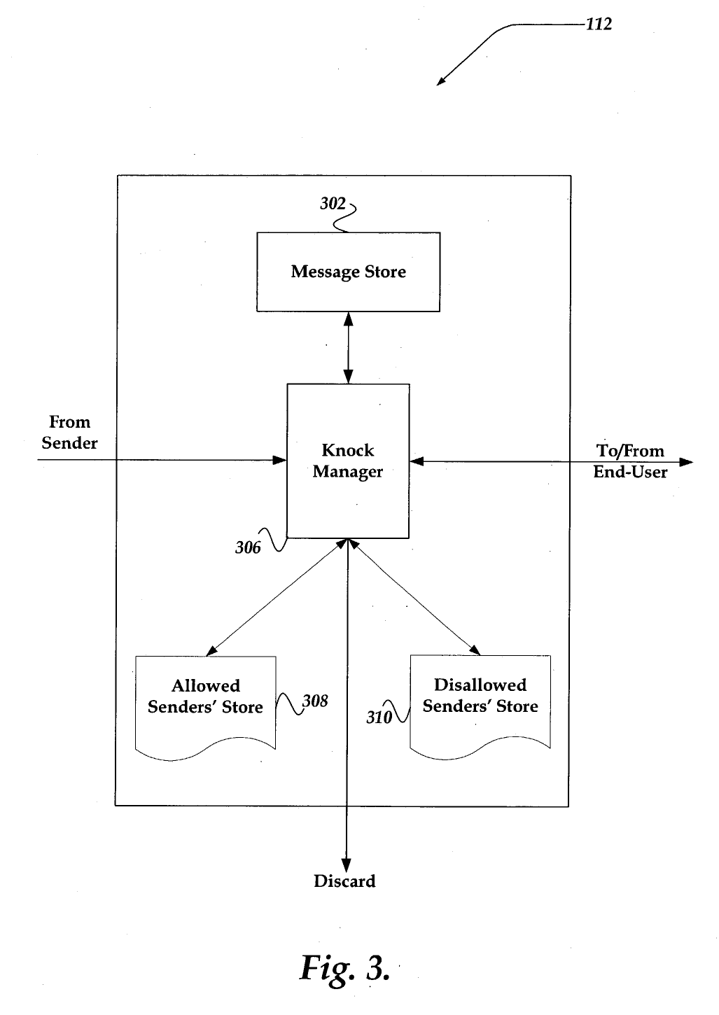

Server computer 110 includes knock notifier 112, which is described in more detail below, in conjunction with FIG. 3. Briefly, however, knock notifier 112 is configured to manage a knock notification to end-user 114 for a message received from an unknown sender. Knock notifier 112 further determines whether a message is to be forwarded to end-user computer 114, discarded, and the like. Although not shown, server computer 110 may also include a message delivery system that is in communication with knock notifier 112. In one embodiment, the message delivery system employs Simple Mail Transfer Protocol (SMTP). The message delivery system may further include a Post Office Protocol (POP) server, Internet Message Access Protocol (IMAP) server, and the like. However, the present invention is not so limited. For example, the message delivery system may include cc:Mail, Microsoft Mail, Professional Office System (PROFS), Distributed Office Support System (DISOSS), and the like, without departing from the scope or spirit of the present invention.

End-user computer 114 may be any device capable of sending and receiving a message over a network, such as WAN/LAN 108. Such devices include cellular telephones, smart phones, display pagers, radio frequency (RF) devices, infrared (IR) devices, integrated devices combining one or more of the preceding devices, and the like. End-user computer 114 may also include other devices, such as PDAs, handheld computers, tablet computers, personal computers, multiprocessor systems, microprocessor-based or programmable consumer electronics, network PCs, wearable computers, and the like. As such, end-user devices typically range widely in terms of capabilities and features. For example, a cell phone may have a numeric keypad and a few lines of monochrome LCD display on which only text may be displayed. A web-enabled client device may have a touch sensitive screen, a stylus, and several lines of color LCD display in which both text and graphics may be displayed. End-user computer 114 may have a keyboard, mouse, speakers, microphone, and a relatively large area on which to display forms. End-user computer 114 further includes low-end devices that may have limited storage memory, reduced application sets, low bandwidth for transmission of a communication, or the like: Such low-end devices may be constrained, for a variety of reasons, to employing a subset of messaging actions.

FIG. 2 shows an exemplary server computer 200 that may be included in a system implementing the invention, according to one embodiment of the invention. Server computer 200 may include many more components than those shown. The components shown, however, are sufficient to disclose an illustrative embodiment for practicing the invention.

Server computer 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server computer 200. Any general-purpose operating system may be employed. Basic input/output system (“BIOS”) 218 is also provided for controlling the low-level operation of server computer 200. As illustrated in FIG. 2, server computer 200 also can communicate with the Internet, or some other communications network, such as WAN/LAN 108 in FIG. 1, via network interface unit 210, which is constructed for use with various communication protocols including the TCP/IP protocol. Network interface unit 210 is sometimes known as a transceiver or transceiving device.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, allowed and disallowed senders' stores, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the mass memory stores program code and data for implementing knock notifier 110. The mass memory may also store additional program code and data for performing the functions of server computer 200. One or more applications 250 are loaded into mass memory and run on operating system 220.

Server computer 200 may also include an SMTP handler application for transmitting and receiving email for a message delivery system, an HTTP handler application for receiving and handing HTTP requests, and an HTTPS handler application for handling secure connections. The HTTPS handler application may initiate communication with an external application in a secure fashion.

Server computer 200 also includes input/output interface 224 for communicating with external devices, such as a mouse, keyboard, scanner, or other input devices not shown in FIG. 2. Likewise, server computer 200 may further include additional mass storage facilities such as CD-ROM/DVD-ROM drive 226 and hard disk drive 228. Hard disk drive 228 is utilized by server computer 200 to store, among other things, application programs, databases, message stores, allowed and disallowed senders' data stores, and the like.

FIG. 3 illustrates components of one embodiment of a knock notifier, such as shown in FIG. 1. Knock notifier 112 may include many more components than those shown; however, those shown are sufficient to disclose an illustrative embodiment for practicing the invention.

As shown in the figure, knock notifier 112 includes message store 302, knock manager 306, allowed senders' store 308, and disallowed senders' store 310. Knock manager 306 is in communication with message store 302, allowed senders' store 308, and disallowed senders' store 310.

Message store 302 is configured to retain a received message from an unknown sender, and the like. Message store 302 may be implemented as a buffer, file, database, folder, and the like.

Allowed senders' store 308 includes a list, database, folder, file, buffer, and the like, configured to manage and store information associated with an allowed message sender. Information associated with an allowed message sender may include, but is not limited to, a name associated with of a message sender, an alias of a message sender, a network address, server address, IP address, service provider, domain address, email address, and the like.

An allowed message sender includes a message sender that the associated end-user may be willing to receive a message from. Allowed senders' store 308 may be generated from the associated end-user's email address list, contact list, message rule, file, database, folder, and the like. Allowed senders' store 308 may be configured to enable an end-user to revise its content, format, and the like.

Disallowed senders' store 310 includes a list, database, folder, file, buffer, and the like, configured to manage and store information associated with a disallowed message sender. Information associated with a disallowed message sender may include a name associated with of a message sender, an alias of a message sender, a network address, server address, IP address, service provider, domain address, email address, and the like.

A disallowed message sender includes a message sender that the associated end-user is unwilling to receive a message from. Disallowed senders' store 310 may be generated from the associated end-user's email address list, contact list, message rule, and the like. Disallowed senders' store 310 may be configured to enable an end-user to revise its contents, format, and the like.

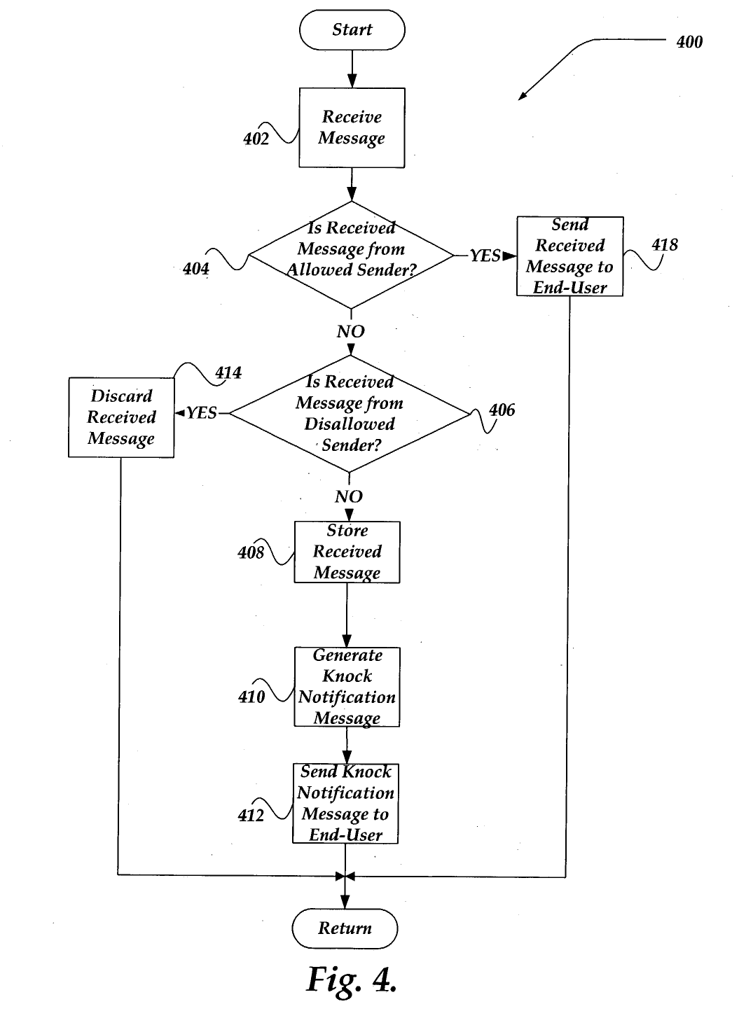

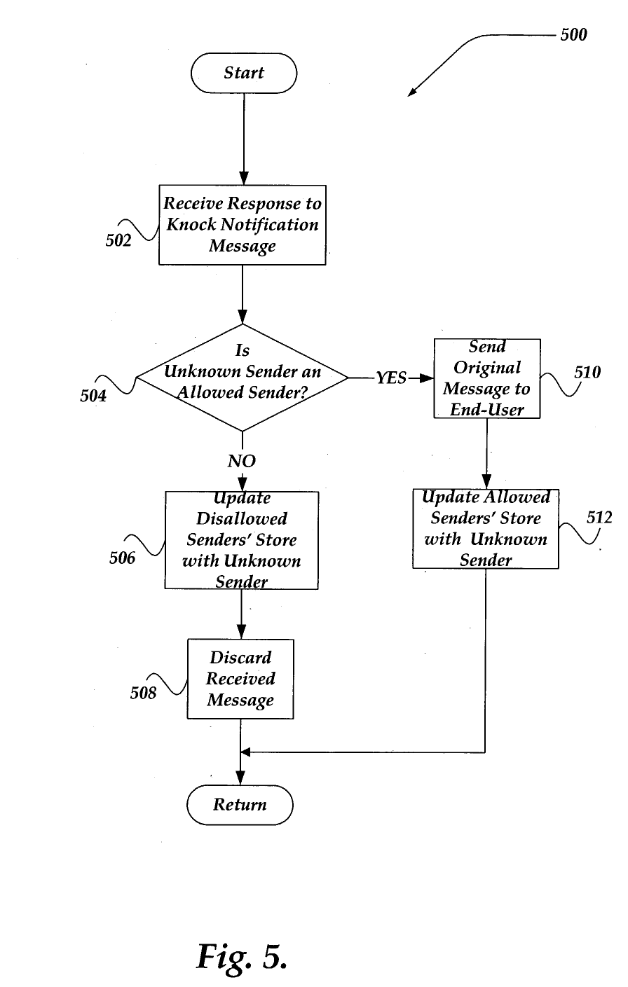

Knock manager 306 is configured to receive and manage a delivery of a message, such as an email, by performing actions described below in conjunction with FIGS. 4-5. Briefly, knock manager 306 employs information included within allowed senders' store 308 and disallowed senders' store 310 to determine how to direct the received message. If knock manager 306 determines that the received message is from an allowed sender, as determined by information associated with allowed senders' store 308, the received message is forwarded to the end-user. If knock manager 306 determines that the received message is from a disallowed sender, as determined by information associated with the disallowed senders' store 310, the received message is discarded. In one embodiment, knock manager 306 sends a response to the received message, requesting removal from a senders' distribution list, buddy list, contact list, and the like. If knock manager 306 determines that the sender of the received message is an unknown sender, knock manager 306 sends the end-user a knock notification message. Based on a response to the knock notification message, knock manager 306 may add the unknown sender to allowed senders' store 308, disallowed senders' store 310, and the like.

Although not shown, knock notifier 112 may communicate with a mail delivery system. For example, knock notifier 112 may receive the received message from the sender through the mail delivery system. Knock notifier 112 may also forward the message and the knock notification message to the mail delivery system. The mail delivery system may then forward the message and knock notification message to an appropriate inbox, folder, and the like, associated with the end-user.

Generalized Operation

The operation of certain aspects of the present invention will now be described with respect to FIGS. 4-5. FIG. 4 illustrates a flow chart for one embodiment of an overview process 400 for generating a knock notification message in response to a message from an unknown sender. Process 400 may operate, for example, within knock notifier 112 in FIG. 1.

Process 400 begins, after a start block, at block 402, when a message is received, typically from a message sender, such as illustrated in FIG. 1.

Processing continues to decision block 404, where a determination is made whether the received message is from an allowed sender. An allowed sender may be determined by performing a search of the allowed senders' store to locate a match of information associated with the sender of the received message. If it is determined that a match is located, processing branches to block 418; otherwise, processing branches to decision block 406.

At block 418, the received message is forwarded to the end-user. In one embodiment, forwarding the received message includes forwarding the received message to an email inbox associated with the end-user. Upon completion of block 418, processing returns to perform other actions.

At decision block 406, a determination is made whether the received message is from a disallowed sender. A disallowed sender may be determined by performing a search of the disallowed senders' store to locate a match to information associated with the sender of the received message. If it is determined that a match is located, that is, the sender of the received message is known, but disallowed, processing branches to block 414, where the received message is discarded. Upon completion of block 414, processing returns to perform other actions.

Alternatively, at decision block 406, if a match is not located, then the sender is considered to be an unknown sender to the end-user, and processing continues to block 408, where the received message is stored for further processing. The received message may be stored in a data store, including, but not limited to, a folder, list, database, and the like.

Processing continues to block 410, where a knock notification message is generated. The knock notification message may be automatically generated. In one embodiment, the knock notification message includes the information associated with the sender of the received message, such as the sender's identity, and a mechanism to enable the end-user to allow/disallow forwarding of the received message to the end-user. The allow/disallow mechanism may include any of a variety of techniques, including allow/disallow buttons, voting selections, a configured reply format, and the like. By not including the received message content in the knock notification message, the present invention is directed at minimizing a purpose for sending an unsolicited message.

The knock notification message, however, may include additional information. For example, the knock notification message may include a capability to enable the end-user to view at least a portion of the content of the received message, without departing from the scope or spirit of the present invention.

Processing continues to block 412, where the knock notification message is forwarded to the end-user. In one embodiment, the knock notification message is forwarded to a knock folder, such as an email folder, associated with the end-user. Upon completion of block 412, processing returns to perform other actions.

FIG. 5 illustrates a flow chart for one embodiment of a process for managing a message from an unknown sender based on a response to a knock notification message, in accordance with the present invention. Process 500 may operate, for example, within knock notifier 112 in FIG. 1.

Process 500 begins, after a start block, at block 502, where a response to the knock notification message of FIG. 4 is received. Processing continues to decision block 504, where a determination is made whether the response indicates that the unknown sender of the received message of FIG. 4 is allowed. If the unknown sender is allowed, processing branches to block 510; otherwise, processing branches to block 506.

At block 506, the disallowed senders' store is updated to include information associated with the sender of the received message. Processing continues to block 508, where the received message for the now disallowed sender is discarded. Upon completion of block 508, processing returns to perform other actions.

At block 510, the received message is forwarded to the end-user. In one embodiment, forwarding the received message includes forwarding the received message to an email inbox associated with the end-user. Forwarding the received message to an email inbox may include forwarding the received message to a mail delivery system, which in turn forwards the received message to the appropriate email inbox. Processing continues to block 512, where the allowed senders' store is updated to include information associated with the now allowed sender. Upon completion of block 512, processing returns to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A method of managing delivery of a message, comprising:
receiving the message from a sender;
forwarding the received message to a destination when the sender is allowed;
discarding the received message when the sender is disallowed; and
forwarding a knock notification message to another destination when the sender is unknown.

2. The method of claim 1, further comprising:
receiving a response to the knock notification message;
determining when the response indicates the unknown sender is allowed, and when unknown sender is allowed, forwarding the received message to the destination; and
determining when the response indicates the unknown sender is disallowed, and when the unknown sender is disallowed, discarding the received message.

3. The method of claim 2, wherein discarding the received message further comprises, updating a disallowed senders' data store to include information associated with the unknown sender.

4. The method of claim 2, wherein forwarding the received message further comprises, updating an allowed senders' data store to include information associated with the unknown sender.

5. The method of claim 1, wherein forwarding the received message to the destination further comprises, forwarding the received message to an email inbox.

6. The method of claim 1, wherein forwarding the knock notification message to another destination further comprises, forwarding the knock notification message to an email knock folder.

7. The method of claim 1, wherein the knock notification message further comprises at least one of information associated with the sender of the received message, and a mechanism to select at least one of an allow, and a disallow of the received message.

8. The method of claim 1, wherein the message is an electronic mail message.

9. A computer-readable medium having computer-executable components for managing delivery of a message, comprising:
a mail delivery component for receiving the message from a sender and sending the message to an end-user; and
a knock manager component coupled to the mail delivery component, that is arranged to perform actions, including:
forwarding the received message to a end-user when the sender is an allowed sender;
discarding the received message when the sender is a disallowed sender; and
forwarding a knock notification message to the end-user when the sender is an unknown sender.

10. The computer-readable medium of claim 9, further comprising:
receiving a response to the knock notification message from the end-user;
determining when the response indicates the unknown sender is allowed, and when the unknown sender is allowed, forwarding the received message to the end-user; and
determining when the response indicates the unknown sender is disallowed, and when the unknown sender is disallowed, discarding the received message.

11. The computer-readable medium of claim 10, wherein discarding the received message further comprises, updating a disallowed senders' data store to include information associated with the sender.

12. The computer-readable medium of claim 10, wherein forwarding the received message further comprises, updating an allowed senders' data store to include information associated with the sender.

13. The computer-readable medium of claim 9, wherein the mail delivery system includes at least one of a Post Office Protocol (POP) server, Internet Message Access Protocol (IMAP) server, cc:Mail, Microsoft Mail, Professional Office System (PROFS), and a Distributed Office Support System (DISOSS).

14. The computer-readable medium of claim 9, wherein forwarding the received message to the end-user further comprises forwarding the received message to an email inbox associated with the end-user.

15. The computer-readable medium of claim 9, wherein forwarding the knock notification message to the end-user further comprises forwarding the knock notification message to an email knock folder associated with the end-user.

16. The computer-readable medium of claim 9, wherein the knock notification message further comprises at least one of information associated with the sender of the received message, and a mechanism to select at least one of an allow, a disallow of the received message, and a view of at least a portion of the received message.

17. The computer-readable medium of claim 9, wherein the knock notifier further comprises:
an allowed senders' data store configured to retain information associated with an allowed sender; and
a disallowed senders' data store configured to retain information associated with a disallowed sender.

18. A system for managing a delivery of a message, comprising:
a mail delivery component configured to receive the message from a sender and to send the message to an end-user; and
a knock manager component, coupled to the mail delivery component, that is configured to perform actions, including:
receiving the message from the mail delivery component;
forwarding the received message to an end-user when the sender is an allowed sender;
discarding the received message when the sender is a disallowed sender; and
forwarding a knock notification message to the end-user when the sender is an unknown sender.

19. The system of claim 18, wherein forwarding the received message to the end-user further comprises forwarding the received message to an email inbox associated with the end-user.

20. The system of claim 18, wherein forwarding the knock notification message to the end-user further comprises forwarding the knock notification message to an email knock folder associated with the end-user.

21. The system of claim 18, wherein the knock notification message further comprises at least one of an identity associated with the sender, and a mechanism to select at least one of an allow, and a disallow of the received message.

22. The system of claim 18, wherein forwarding the knock notification message further comprises generating the knock notification message based in part on information associated with the sender.

23. An apparatus for managing a delivery of a message, comprising:
means for receiving the message;
means for transmitting the message to a destination;
means for forwarding the message to the destination based in part on whether the sender of the message is an allowed sender;
means for discarding the message based in part on whether the sender of the message is a disallowed sender;
means for generating a knock notification message based in part on whether the sender of the message is an unknown sender;
means for receiving a response to the knock notification message;
means for forwarding the received message when the response indicates the unknown sender is allowed; and
means for discarding the received message when the response indicates the unknown sender is disallowed.
